(19) United States
(12) Patent Application Publication
(10) Pub. No.: US 2017/0356264 A1
(43) Pub. Date: Dec. 14, 2017

(54) CONTROL SYSTEM AND METHOD FOR SUPPLY OF POWER TO ACTIVE MAGNETIC BEARINGS IN A ROTATING MACHINE

(71) Applicant: VETCO GRAY SCANDINAVIA AS, Sandvika (NO)

(72) Inventors: Jorgen CORNELIUSSEN, Kolsas (NO); Trond Martin AUGUSTSON, Sandvika (NO); Sudhir CHAMBHARE, Oslo (NO); Massimiliano Ortiz NERI, Florence (IT)

(21) Appl. No.: 15/536,256

(22) PCT Filed: Dec. 8, 2015
(86) PCT No.: PCT/EP2015/079031

§ 371 Date: Jun. 15, 2017

(30) Foreign Application Priority Data
Dec. 18, 2014 (NO) 20141543

(51) Int. Cl. E21B 33/035; G05B 9/03; F16C 32/04

(52) U.S. Cl. CPC E21B 33/0355; F16C 32/0457; G05B 9/03; F16C 32/0442

(57) ABSTRACT

A control system and a method arranged for redundant supply of power to active magnetic bearings adapted for support of a shaft or rotor in a rotating machine. The control system comprises at least two control modules which are supplied external power. The control modules are connectable to a base module comprising a first set of power and sensor signal pathways which can be switched in to provide contact between a first control module and the active magnetic bearings, and a second set of power and sensor signal pathways which can be switched in to provide contact between a second control module and the active magnetic bearings. Each control module comprises a switching mechanism which is controllable for connecting the control modules one at a time to the active magnetic bearings via the first set or via the second set of power and sensor signal pathways.

### BACKGROUND OF THE INVENTION

The present invention refers to systems and methods for controlling the operation of active magnetic bearings, AMBs, in their implementations in rotating machines, such as pumps or compressors.

In one aspect of the invention a control system is arranged for redundant power supply to stator coils in active magnetic bearings, AMBs, adapted for the support and journaling of a rotor or shaft in a rotating machine. In another aspect of the invention a method is provided for redundant operation control of the active magnetic bearings.

In other words, embodiments of the invention provides a redundant control system and method designed to ensure continued operation or minimized shutdown periods in case of failure in the power supply or control of the active magnetic bearings. The redundancy makes the system and method suitable for implementation in rotating machines which are operated at locations that are difficult to access. An embodiment of the invention is especially useful in subsea installations.

Active magnetic bearings can be arranged for contact-free support in both radial and axial directions of a rotor or rotor shaft in a pump or compressor. In the active magnetic bearing, briefly, a magnetic conductive rotor is journalled in a stator that is magnetized by current fed through appropriate electric windings of the stator. The magnetic field generated by the stator windings or stator coils induces the magnetic force needed to support the rotor in levitation relative to the stator. The currents to the stator coils are actively modulated on the basis of a feedback rotor position signal. The feedback rotor position signal is provided by a sensor (inductive or eddy current sensor) which is reacting to changes in the position of the rotor relative to the sensors and other stationary parts of the compressor, such as the stator. The detected change in position is used in an AMB controller that controls the supply of current to the stator coils correspondingly, this way urging the rotor to maintain a centered position in the bearing. The AMB controller is usually located at a short distance from the bearing for short signal pathways and fast response.

In continuing processes, such as in the recovery and transport of oil and gas in subsea hydrocarbon production, e.g., pumps or compressors are required to run on a continuous basis and shutdown periods need to be kept at a minimum. In order to accomplish reliable and continuous operation in a subsea pump or compressor, back-up control systems and power supply can be installed to provide redundancy.

An example of a redundant subsea control system and method is previously known. A subsea control module comprising a hydraulic manifold and two retrievable subsea electronic modules. The electronic modules are both connected to the hydraulic manifold via separate wet-mate connectors and multiplexer and de-multiplexer electronics such that the control module can operate using only one or both electronic modules concurrently.

It is also previously known to provide redundancy in the architecture of an AMB control system by using a shared change-over module configured to switch operation between two equally equipped electronic control modules. The shared change over-module comprises the software required to route power and control signals between the AMB and the currently active control module.

A drawback with the latter system is that the shared switching functionality constitutes a single point of failure, in other words redundancy is lost in case of failure in the change-over module. Another drawback is the complexity in both software management and in the electric and electronic architecture required for routing all power and communication, from both control modules, via the common change-over module.

### SUMMARY OF THE INVENTION

An object of an embodiment of the present invention is to provide an AMB control system and method which avoid the drawbacks of prior art systems and methods for AMB control.

According to one aspect of the invention the object is met in a control system arranged for supply of power to active magnetic bearings (AMBs) adapted for support of a shaft or rotor in a rotating machine, the control system comprising: at least two control modules which are supplied external power, the control modules connectable to a base module comprising a first set of power and sensor signal pathways which can be switched in to provide contact between a first control module and the active magnetic bearings, and a second set of power and sensor signal pathways which can be switched in to provide contact between a second control module and the active magnetic bearings, wherein each control module comprises a switching mechanism respectively which is controllable for connecting the control modules, one at a time, to the active magnetic bearings via the first set or via the second set of power and sensor signal pathways.

The control modules are more particularly equivalently equipped at least with respect to components which are essential for power supply and control of the active magnetic bearings, such as a control unit, a power module and a sensor signal processor. Each control module may further comprise ON/OFF connections and an electro-mechanical or electronic mechanism which is controllable for switching the connections between ON and OFF positions.

Via power and signal splitters internally in the base module, the first and second sets of power and sensor signal pathways share a common set of IN/OUT connections arranged at a coupling interface between the base module and the active magnetic bearings.

In one embodiment the switching mechanism is actuated via the control unit. In another embodiment, the switching mechanism can be actuated directly from the external power supply, the switching command then by-passing the control unit.

The control modules and the base module can be mechanically connected and retrievable as a unit. However, in another embodiment at least one of the base module and the control modules is arranged to be individually retrievable separate from the other one. The control modules may for example be housed together in a common canister which is retrievable separate from the base module. In another embodiment the control modules are housed in separate canisters which are individually retrievable from the base module.

In an embodiment the control system comprises processor capacity configured for execution of control logic carrying instructions for: i) powering the active magnetic bearings by activation of one control module, ii) generation of a machine permissive-to-start signal, iii) monitoring the operational state of the active control module, iv) upon detected failure in the active control module: generation of machine shutdown request, v) waiting for machine to stop, then: vi) de-activation of the currently active control module and activation of another control module, vii) generation of a machine permissive-to-restart signal, and repeating steps iii) to vii) if appropriate.

In an embodiment, the external power supplies to the control modules are individually controlled by superior control logic arranged to prevent simultaneous powering of the control modules. The superior control logic may include a machine operation control.

Another aspect of the invention provides a method for supplying power to active magnetic bearings through a control system, the method comprising: connecting one control module to the active magnetic bearings by actuation of a power switching mechanism of said control module, generating and transmitting a signal to machine operation control as permissive-to-start of a rotating machine, monitoring the operational state of the active control module, upon detected failure in the active control module: generating a signal to machine operation control requesting shutdown of the machine, waiting for the machine to stop before de-activation of the currently active control module, connecting another control module to the active magnetic bearings by actuation of a power switching mechanism of said other control module, generating and transmitting a signal to machine operation control as permissive-to-restart of the rotating machine, and repeating, where appropriate, the sequence from the monitoring step above.

The control modules can be powered simultaneously, the switching mechanism then preventing short circuiting by activation of the control modules one at a time.

However, according to one embodiment the method comprises individual powering of the control modules via separate external power supplies which are controlled for preventing simultaneous activation of the control modules.

### BRIEF DESCRIPTION OF THE DRAWINGS

The invention will be further explained below with reference to the appended drawings wherein embodiments of the invention are shown schematically. In the drawings,

FIG. 1 is a block diagram schematically showing the components of the redundant AMB control system installed on a rotating machine in accordance with an embodiment, and

FIG. 2 is a flow chart illustrating the fundamental steps of the logic that operates the redundant AMB control system in accordance with an embodiment.

### DETAILED DESCRIPTION

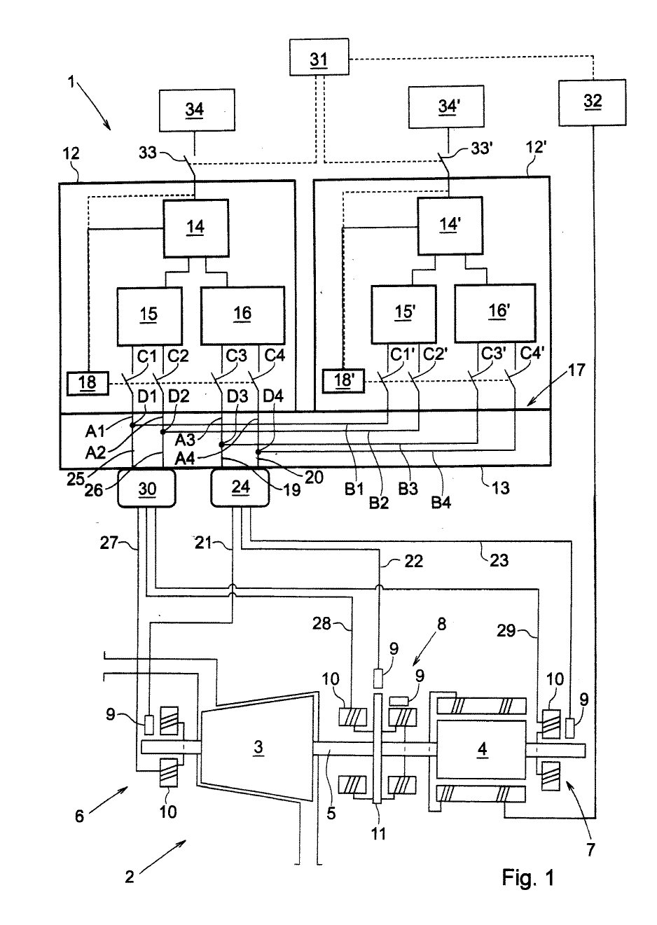

With reference to FIG. 1, an AMB control system 1 is schematically shown in association with a rotating machine 2.

The rotating machine, which can be a pump or a compressor, has a rotor 3 driven for rotation by a motor 4 which is drivingly connected to the rotor via a shaft 5. The rotor and shaft are supported in active magnetic bearings 6, 7 and 8 in which the rotor is levitated for contact-free rotation. The position of the rotor is monitored by position sensors 9 that continuously detect the position of the rotor position relative to electromagnets or stator coils 10. In the example of a rotating machine layout depicted in FIG. 1 the rotor 3 is journalled in radial bearings 6 and 7 levitating the rotor and counteracting the weight of the rotor (in horizontal orientation) and the radial loads and forces that act on the rotor from the process load. The rotor 3 is further journalled in thrust bearing(s) 8 which hold(s) the rotor in levitation while compensating for and counteracting the axial load acting on the rotor from the process load. The stator coils 10 of the thrust bearing 8 are arranged on opposite sides of a thrust disc 11 which is fixed onto the rotor shaft 5.

The principal structure of active magnetic bearings is a well-known technology per se, and need not be further discussed here. It shall however be noted that different implementations may require other numbers of bearings, stator coils and sensors, as well as different types of sensors and stator coils. In other embodiments, obviously, the rotor 3 may be supported to have a vertical orientation. Obviously, the invention is not limited to the number of bearings, stator coils, sensors and orientation as shown in the drawing for purpose of illustration.

Auxiliary bearings are typically arranged to protect the magnetic bearings from contact with the rotor during electrical power black-out or process overload. Auxiliary bearings are omitted from the drawing of FIG. 1 for reason of simplicity.

Based on the rotor position detected by the position sensors 9, the AMB control system 1 regulates and supplies the amount of current to the stator coils 10 that is required to maintain the rotor in contact-free rotation or levitation, compensating and counteracting a change or deviation in the rotor's position relative to ideal positions in the active magnetic bearings 6-8.

Basic components of the AMB control system 1 are two or more electronic control modules 12 and 12′ which can be alternatingly activated for power supply and control of the active magnetic bearings 6-8 via a common base module 13.

Each control module 12 and 12′ comprises a corresponding set of electronic components involved in signal processing and in the supply of power to the active magnetic bearings 6-8. The control modules are equally equipped at least with respect to a control unit 14, 14′, a power module 15, 15′ and a sensor signal processor 16, 16′.

The components 14-16 or 14′-16′ of the control modules 12, 12′ can be electrically connected to the base module 13 via ON/OFF connections C1-C4 of the first control module 12, or via the ON/OFF connections C1′-C4′ of the second control module 12′ respectively. In connected position, the ON/OFF connections C1-C4 and C1′-C4′ mate with terminals (not shown) to first and second sets of power and sensor signal pathways in the base module 13 which are terminated at a coupling interface 17 between the base module 13 and the control modules 12, 12′.

The coupling interface 17 may comprise dry mate connectors, e.g. Dry mate connectors at the interface 17 may be supported on the control modules or supported on the base module as appropriate, and may alternatively be realized as separate devices connectable between the control and base modules.

The states of the ON/OFF connections of the control modules are governed by an ON/OFF switching mechanism 18 or 18′, respectively. The switching mechanism 18, 18′ can be realized in the form of an electromechanical coupler or relay, or in the form of an electronic power switch, e.g. The switching mechanism 18, 18′ can also be seen as a controller which initiates the making and braking of power and signal pathways between the base module and the subject control module by actuation of appropriate switching devices. If appropriate, the switching mechanism of a control module 12 or 12′ may be arranged to comprise separate switching mechanism modules that are dedicated and controlled for activation of power and signal wire switches respectively. In either case, the switching mechanism can be arranged to respond to a command generated in the associated control unit 14, 14′ for switching on or off the associated connections, respectively.

The base module 13 comprises IN/OUT connections in the form of sensor signal inputs 19 and 20 for incoming rotor position signals from the position sensors 9, transmitted via signal wires 21, 22 and 23 to a coupling interface 24 located between the control system 1 and the rotating machine 2. The base module 14 further comprises IN/OUT connections in the form of power output connections 25 and 26 for supplying power to the AMB stator coils 10 via power leads 27, 28 and 29, over a coupling interface 30.

The coupling interfaces 24 and 30 can be realized as wet mate connectors. Wet mate connectors at the interfaces 24, 30 may be supported on the base module as appropriate, and may alternatively be realized as separate devices connectable to the base module.

Internally in the base module a first set of power and sensor signal pathways A1-A4 can be switched in to provide electrical contact between the control module 12 and the coils and sensors of the active magnetic bearings. Via splitters D1-D4 on the first set of power and signal pathways, a second set of power and signal pathways B1-B4 can be switched in to provide contact between the control module 12′ and the coils and sensors of the active magnetic bearings. The power and signal pathways and splitters may be arranged in a dielectric medium such as oil or gas that fills the inner space of the base module.

The decision to activate or de-activate the first and second control modules is made in a superordinate controller 31 which is arranged to energize the control modules 12, 12′ one at a time, preventing simultaneous activation of both modules. The controller 31 correlates the switching in and out of the control modules 12 and 12′ with the operational status of the motor 4 of the rotating machine 2. To this purpose the controller 31 communicates with an overall machine operation control (not shown)—alternatively the controller 31 may itself comprise the necessary logic and functionality to initiate start and stop of the motor 4, in which case the controller 31 acts as the machine operation controller which regulates the supply of external power 32 to the motor.

The controller 31 may be arranged subsea or in a topside location.

The controller 31 controls the supply of electric power to the control modules via power switches 33 and 33′ connecting the control modules to separate incoming power supplies 34 and 34′, respectively. The individual power supplies can be used for direct actuation of the switching mechanism 18, 18′, in this case by-passing the control unit 14, 14′ as indicated by broken lines in FIG. 1.

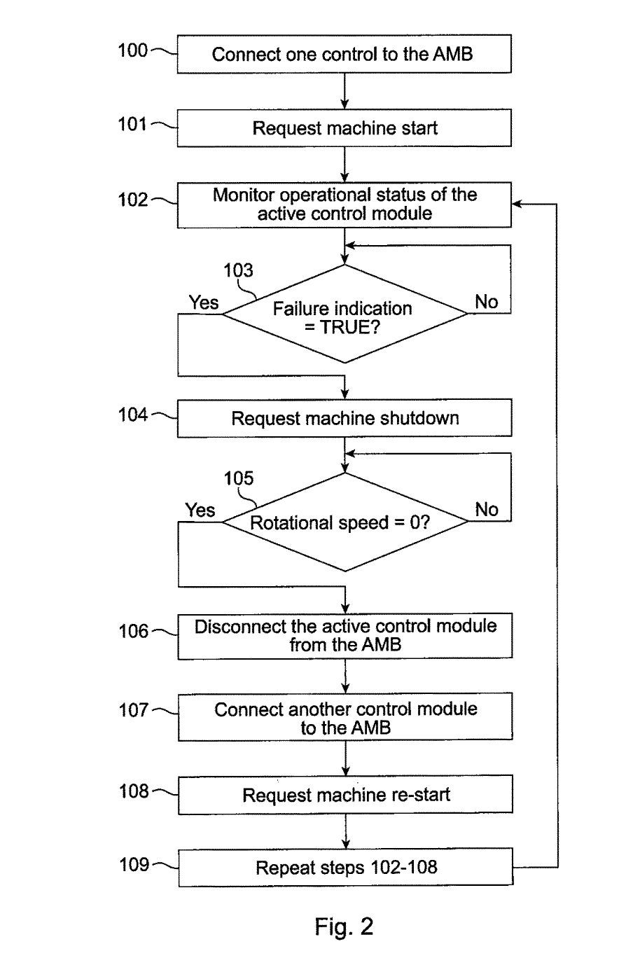

The functionality provided by the control system 1 will now be summarized with reference made also to the flow chart of FIG. 2. The flow chart of FIG. 2 illustrates the sequential steps of the control method which is made available by implementation of the redundant AMB control system of an embodiment of the present invention:

Step 100: initiate operation of the rotating machine by connecting one control module to the AMB;

Step 101: generate and transmit to machine operation control a permissive-to-start signal for start of the rotating machine;

Step 102: monitor the operational status of the active control module on a frequent or continuous basis;

Step 103: evaluate an indication of failure in the operation of the active control module, and if the failure indication is found to be true, then

Step 104: request for shutdown of the rotating machine;

Step 105: monitor the speed of rotation in the rotating machine, and if rotational speed is 0, then

Step 106: disconnect the active control module from the AMB;

Step 107: connect another control module to the AMB;

Step 108: generate and transmit to machine operation control a permissive-to-restart signal for restart of the rotating machine, and

Step 109: repeat the steps 102-108 if appropriate.

The logic that governs the AMB control process is software instructions which are stored in a readable memory and executable in a processor or PLC (Programmable Logic Controller) or DCS (Distributed Control System) that can be integrated in the controller 31 or in the control unit 14 or 14′, where appropriate with support from the associated controller 31.

The control unit 14, 14′ may further comprise a self-diagnosis functionality by which the operational status of the active control module is monitored, and deviations from a normal condition can be detected and identified over time.

In one embodiment, the benefits of which are easy to see, the first and second control modules can be arranged disconnectable from the base module so as to be separately retrievable for replacement or service while the other control module is operating.

The control modules, as well as the base module, can be housed in pressurized or pressure compensated canisters for subsea use. The canisters may be designed for handling by an ROV (Remotely Operated underwater Vehicle). All canisters may be filled with dielectric media to prevent short circuitry or partial discharges.

Some of the advantages that may be provided by embodiments of the present invention can be summarized as: simplification of the AMB control system, simplification of the AMB remote control, possibility to increase the redundancy, easier procedure for test, and cost reduction

Although the invention has been explained with reference to embodiments comprising two exchangeable control modules it will be implicitly understood that the system and method may alternatively be designed for three or more interchangeable control modules. Other conceivable modifications comprise, e.g., arranging the switching mechanisms in separate containers; splitting the base module into separate units, or combination of power and sensor signals on the same conductor. These and other modifications which can be derived from the present disclosure shall be considered to fall within the scope of the appended claims.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A control system arranged for supply of power to active magnetic bearings adapted for support of a shaft or rotor in a rotating machine, the control system comprising:
at least two control modules supplied by external power;
the control modules connectable to a base module comprising a first set of power and sensor signal pathways configured to be switched in to provide contact between a first control module and the active magnetic bearings, and a second set of power and sensor signal pathways configured to be switched in to provide contact between a second control module and the active magnetic bearings;
wherein each control module comprises a switching mechanism which is controllable for connecting the control modules, one at a time, to the active magnetic bearings via the first set or via the second set of power and sensor signal pathways.

2. The control system of claim 1, wherein the control modules are equivalently equipped with respect to at least the following components:
a control unit;
a power module;
a sensor signal processor;
wherein each control module further comprises ON/OFF connections and an electro-mechanical or electronic mechanism which is operable for switching the connections between ON and OFF positions.

3. The control system of claim 1, wherein the first and second sets of power and sensor signal pathways via power and signal splitters internally in the base module share a common set of IN/OUT connections at a coupling interface between the base module and the active magnetic bearings.

4. The control system of claim 2, wherein the switching mechanism is actuated via the control unit.

5. The control system of claim 2, wherein the switching mechanism is actuated directly from the external power supply by-passing the control unit.

6. The control system of claim 1, wherein at least one of the base module and the control modules are individually retrievable.

7. The control system of claim 6, wherein the control modules are housed together in a common canister retrievable from the base module.

8. The control system of claim 6, wherein the control modules are housed in separate canisters which are individually retrievable from the base module.

9. The control system of claim 1, comprising processor capacity for execution of control logic carrying instructions for:
i) powering the active magnetic bearings by activation of one electronic control module;
ii) generation of a permissive-to-start signal for the rotating machine;
iii) monitoring the operational state of the active control module;
iv) upon detected failure in the active control module: generation of machine shutdown request;
v) waiting for the rotating machine to stop, then:
vi) de-activation of the currently active control module and activation of another control module; and
vii) generation of a permissive-to-restart signal for the rotating machine, and if appropriate, repeating steps iii) to vii).

10. The control system of claim 1, wherein the external power supplies to the control modules are individually controlled by superior control logic preventing simultaneous powering of the control modules.

11. The control system of claim 10, wherein the superior control logic includes a machine operation control.

12. A method for supplying power to active magnetic bearings, the method comprising:
connecting one control module to active magnetic bearings by actuation of a power switching mechanism of the control module;
generating and transmitting to machine operation control a permissive-to-start signal for start of a rotating machine;
monitoring the operational state of the active control module;
upon detected failure in the active control module: generating a signal to the machine operation control requesting shutdown of the rotating machine;
waiting for the machine to stop before de-activation of the currently active control module;
connecting another control module to the active magnetic bearings by actuation of a power switching mechanism of the other control module;
generating and transmitting to the machine operation control a permissive to restart signal for restart of the rotating machine;
and repeating the sequence from the monitoring step above.

13. The method of claim 12, comprising individual powering of the control modules via separate external power supplies which are controlled to prevent simultaneous activation of the control modules.
